(19) United States
(12) Patent Application Publication
(10) Pub. No.: US 2018/0068004 A1
(43) Pub. Date: Mar. 8, 2018

(54) SYSTEMS AND METHODS FOR AUTOMATIC TRANSFERRING OF AT LEAST ONE STAGE OF BIG DATA OPERATIONS FROM CENTRALIZED SYSTEMS TO AT LEAST ONE OF EVENT PRODUCERS AND EDGE DEVICES

(71) Applicant: BigStream Solutions, Inc., Mountain View, CA (US)

(72) Inventor: Maysam LAVASANI, Cupertino, CA (US)

(73) Assignee: BigStream Solutions, Inc., Mountain View, CA (US)

(21) Appl. No.: 15/700,002

(22) Filed: Sep. 8, 2017

Related U.S. Application Data
(60) Provisional application No. 62/385,196, filed on Sep. 8, 2016.

(51) Int. Cl. G06F 17/30; H04L 12/801

(52) U.S. Cl. CPC G06F 17/30587; G06F 17/30339; H04L 67/1097; H04L 47/12; G06F 17/30377

(57) ABSTRACT

A system is disclosed that includes machines, distributed nodes, event producers, and edge devices for performing big data applications. In one example, a centralized system for big data services comprises storage to store data for big data services and a plurality of servers coupled to the storage. The plurality of servers perform at least one of ingest, transform, and serve stages of data. A sub-system having an auto transfer feature performs program analysis on computations of the data and automatically detects computations to be transferred from within the centralized system to at least one of an event producer and an edge device.

### RELATED APPLICATIONS

This application claims the benefit of U.S. Provisional Application No. 62/385,196, filed on Sep. 8, 2016, the entire contents of this Provisional application is hereby incorporated by reference.

This application is related to U.S. Non-Provisional application Ser. No. ______, filed on Sep. 8, 2017, the entire contents of this application are hereby incorporated by reference.

### TECHNICAL FIELD

Embodiments described herein generally relate to the field of data processing, and more particularly relates to methods and systems of automated/controlled transferring of at least one stage of big data operations from centralized systems to at least one of event producers and edge devices.

### BACKGROUND

Conventionally, big data is a term for data sets that are so large or complex that traditional data processing applications are not sufficient. Challenges of large data sets include analysis, capture, data curation, search, sharing, storage, transfer, visualization, querying, updating, and information privacy.

In one big data example, if a prior approach issues a SQL query in one place to run against a lot of data that is located in another place, this prior approach creates a significant amount of network traffic, which could be slow and costly. However, this approach can utilize a predicate pushdown to push down parts of the SQL query to the storage layer, and thus filter out some of the data.

### SUMMARY

For one embodiment of the present invention, methods and systems of automated/controlled data transfer of big data computations from centralized systems to at least one of event producers and edge devices are disclosed. In one embodiment, a centralized system for big data services comprises storage to store data for big data services and a plurality of servers coupled to the storage. The plurality of servers perform at least one of ingest, transform, and serve stages of data. A sub-system having an auto transfer feature performs program analysis on computations of the data and automatically detects computations to be transferred from within the centralized system to at least one of an event producer and an edge device. Other features and advantages of embodiments of the present invention will be apparent from the accompanying drawings and from the detailed description that follows below.

### BRIEF DESCRIPTION OF THE DRAWINGS

FIG. 1 shows an embodiment of a block diagram of a big data system 100 for providing big data applications for a plurality of devices in accordance with one embodiment.

FIG. 2 shows an embodiment of a block diagram of a big data architecture 200 for providing big data applications for a plurality of devices in accordance with one embodiment.

FIG. 3 shows an embodiment of a block diagram of a big data architecture 300 having automated controlled intelligence for transferring of big data computations from centralized systems to at least one of distributed nodes, event producers, and edge devices in accordance with one embodiment.

FIG. 4 shows an embodiment of a block diagram of a big data architecture 400 having automated controlled intelligence for transferring of big data computations from centralized systems to at least one of distributed nodes, event producers, and edge devices in accordance with one embodiment.

FIG. 5 shows an embodiment of a block diagram of a big data architecture 500 for processing data from plurality of devices and actuating/commanding the devices based on the processed data in accordance with one embodiment.

FIG. 6 shows an embodiment of a block diagram of a big data architecture 600 having automated transfer of processing and commanding from centralized systems to at least one of distributed nodes, event producers, and edge devices in accordance with one embodiment.

FIGS. 7A and 7B show an example of big data computation that includes three stages running on multiple servers in accordance with one embodiment.

FIG. 8 is a flow diagram illustrating a method 800 for automatically moving operations (e.g., computations, shuffle operations) from a centralized resource to at least one of a distributed resource (e.g., a messaging system, data collection system), an event producer, and an edge device for distributed multi stage dataflow according to an embodiment of the disclosure.

FIG. 9 illustrates the schematic diagram of a data processing system according to an embodiment of the present invention.

FIG. 10 illustrates the schematic diagram of a multi-layer in-line accelerator according to an embodiment of the invention.

FIG. 11 is a diagram of a computer system including a data processing system according to an embodiment of the invention.

### DETAILED DESCRIPTION OF EMBODIMENTS

Methods, systems and apparatuses for to methods and systems of automated/controlled pushing of big data computations from centralized systems to at least one of distributed nodes, event producers, and edge devices are described.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

HW: Hardware.

SW: Software.

I/O: Input/Output.

DMA: Direct Memory Access.

CPU: Central Processing Unit.

FPGA: Field Programmable Gate Arrays.

CGRA: Coarse-Grain Reconfigurable Accelerators.

GPGPU: General-Purpose Graphical Processing Units.

MLWC: Many Light-weight Cores.

ASIC: Application Specific Integrated Circuit.

PCIe: Peripheral Component Interconnect express.

CDFG: Control and Data-Flow Graph.

FIFO: First In, First Out

NIC: Network Interface Card

HLS: High-Level Synthesis

KPN: Kahn Processing Networks (KPN) is a distributed model of computation (MoC) in which a group of deterministic sequential processes are communicating through unbounded FIFO channels. The process network exhibits deterministic behavior that does not depend on various computation or communication delays. A KPN can be mapped onto any accelerator (e.g., FPGA based platform) for embodiments described herein.

Dataflow analysis: An analysis performed by a compiler on the CDFG of the program to determine dependencies between a write operation on a variable and the consequent operations which might be dependent on the written operation.

Accelerator: a specialized HW/SW component that is customized to run an application or a class of applications efficiently.

In-line accelerator: An accelerator for I/O-intensive applications that can send and receive data without CPU involvement. If an in-line accelerator cannot finish the processing of an input data, it passes the data to the CPU for further processing.

Bailout: The process of transitioning the computation associated with an input from an in-line accelerator to a general purpose instruction-based processor (i.e. general purpose core).

Continuation: A kind of bailout that causes the CPU to continue the execution of an input data on an accelerator right after the bailout point.

Rollback: A kind of bailout that causes the CPU to restart the execution of an input data on an accelerator from the beginning or some other known location with related recovery data like a checkpoint.

Gorilla++: A programming model and language with both dataflow and shared-memory constructs as well as a toolset that generates HW/SW from a Gorilla++ description.

GDF: Gorilla dataflow (the execution model of Gorilla++).

GDF node: A building block of a GDF design that receives an input, may apply a computation kernel on the input, and generates corresponding outputs. A GDF design consists of multiple GDF nodes. A GDF node may be realized as a hardware module or a software thread or a hybrid component. Multiple nodes may be realized on the same virtualized hardware module or on a same virtualized software thread.

Engine: A special kind of component such as GDF that contains computation.

Infrastructure component: Memory, synchronization, and communication components.

Computation kernel: The computation that is applied to all input data elements in an engine.

Data state: A set of memory elements that contains the current state of computation in a Gorilla program.

Control State: A pointer to the current state in a state machine, stage in a pipeline, or instruction in a program associated to an engine.

Dataflow token: Components input/output data elements.

Kernel operation: An atomic unit of computation in a kernel. There might not be a one to one mapping between kernel operations and the corresponding realizations as states in a state machine, stages in a pipeline, or instructions running on a general purpose instruction-based processor.

Accelerators can be used for many big data systems that are built from a pipeline of subsystems including data collection and logging layers, a Messaging layer, a Data ingestion layer, a Data enrichment layer, a Data store layer, and an Intelligent extraction layer. Usually data collection and logging layer are done on many distributed nodes. Messaging layers are also distributed. However, ingestion, enrichment, storing, and intelligent extraction happen at the central or semi-central systems. In many cases, ingestions and enrichments need a significant amount of data processing. However, large quantities of data need to be transferred from event producers, distributed data collection and logging layers and messaging layers to the central systems for data processing.

Examples of data collection and logging layers are web servers that are recording website visits by a plurality of users. Other examples include sensors that record a measurement (e.g., temperature, pressure) or security devices that record special packet transfer events. Examples of a messaging layer include a simple copying of the logs, or using more sophisticated messaging systems (e.g., Kafka, Nifi). Examples of ingestion layers include extract, transform, load (ETL) tools that refer to a process in a database usage and particularly in data warehousing. These ETL tools extract data from data sources, transform the data for storing in a proper format or structure for the purposes of querying and analysis, and load the data into a final target (e.g., database, data store, data warehouse). An example of a data enrichment layer is adding geographical information or user data through databases or key value stores. A data store layer can be a simple file system or a database. An intelligent extraction layer usually uses machine learning algorithms to learn from past behavior to predict future behavior.

Typically data collection and logging layers are performed on many distributed nodes. Messaging layers are also distributed. However, ingestion, enrichment, storing, and intelligent extraction happen at the central or semi-central systems. In many cases, ingestions and enrichments need a significant amount of data processing and certain operations, such as filtering and aggregation dramatically decrease a volume of the data. The present design pushes or transfers at least a portion (or an entire amount) of computation associated with ingestion, enrichment, and possibly intelligent extraction to event producers that include edge or end devices to reduce network congestion, reduce transfer of data across networks, and increase processing time.

The present design automatically detects computations that are conventionally performed on ingestion/enrichment or intelligent extractions. In one example, these computations are pushed or transferred to be implemented on the event producer and then perform that computation on the event producer. Alternatively, the computation can even be performed on the data collection layer while the data is getting logged or while data is on the move. In another example, these computations are pushed or transferred to be implemented on edge devices and then perform that computation on the edge device. As a result, this present design leads to a much lower volume of data to be transferred to the central systems, as well as increased utilization of the distributed resources and edge devices, rather than centralized resources.

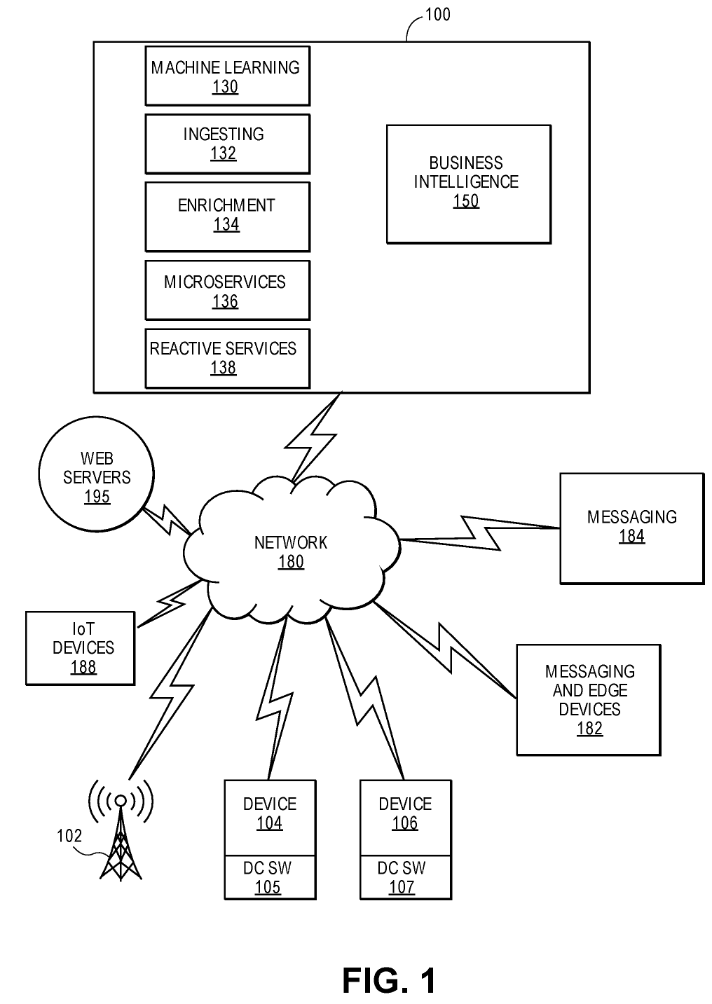

FIG. 1 shows an embodiment of a block diagram of a big data system 100 for providing big data applications for a plurality of devices in accordance with one embodiment. The big data system 100 includes machine learning modules 130, ingestion layer 132, enrichment layer 134, microservices 136 (e.g., microservice architecture), reactive services 138, and business intelligence layer 150. In one example, a microservice architecture is a method of developing software applications as a suite of independently deployable, small, modular services. Each service has a unique process and communicates through a lightweight mechanism. The system 100 provides big data services by collecting data from messaging systems 182 and edge devices, messaging systems 184, web servers 195, communication modules 102, internet of things (IoT) devices 186, and devices 104 and 106 (e.g., source device, client device, mobile phone, tablet device, lap top, computer, connected or hybrid television (TV), IPTV, Internet TV, Web TV, smart TV, satellite device, satellite TV, automobile, airplane, etc.). Each device may include a respective big data application 105, 107 (e.g., a data collecting software layer) for collecting any type of data that is associated with the device (e.g., user data, device type, network connection, display orientation, volume setting, language preference, location, web browsing data, transaction type, purchase data, etc.). The system 100, messaging systems and edge devices 182, messaging systems 184, web servers 195, communication modules 102, internet of things (IoT) devices 186, and devices 104 and 106 communicate via a network 180 (e.g., Internet, wide area network, cellular, WiFi, WiMax, satellite, etc.).

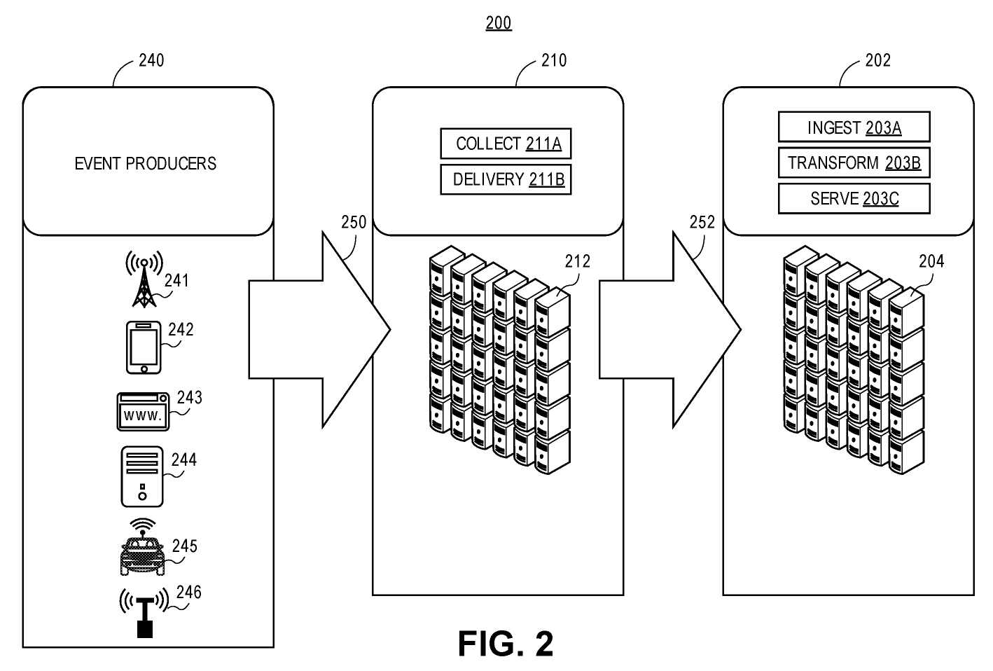

FIG. 2 shows an embodiment of a block diagram of a big data architecture 200 for providing big data applications for a plurality of devices in accordance with one embodiment. A big data system 202 includes a plurality of servers 204 and at least one of ingest 203a, transform 203b, and serve 203c layers or stages. The ingest 203a layer obtains and imports data for immediate use or storage in a database. Data can be streamed in real time or ingested in batches. The transform 203b layer transforms data for storing in a proper format or structure for the purposes of querying and analysis. The serve 203c layer stores processed data and responds to queries. The system 202 provides big data services by collecting data from event producers 240 (e.g., communication modules 241 (e.g., wireless networks), internet of things (IoT) device 245, mobile device 242, tablet device 244, computer 243, sensor device 246, etc.). Each event producer (e.g., edge device) may include a respective big data application (e.g., a data collecting software layer) for collecting any type of data that is associated with the event producer (e.g., user data, device type, network connection, display orientation, volume setting, language preference, location, web browsing data, transaction type, purchase data, etc.). Distributed nodes 210 include collect 211a and delivery layers or stages (e.g., messaging systems) and resources 212 (e.g., web servers). Collected data 250 is transferred from the event producers to the distributed nodes 210 that transfer collected data 252 to the big data system 202 having at least one of ingest 203a, transform 203b, and serve 203c layers or stages that filter the collected and/or transformed data. In one example, the filtering includes selecting a customer ID from a log in which customer country is US.

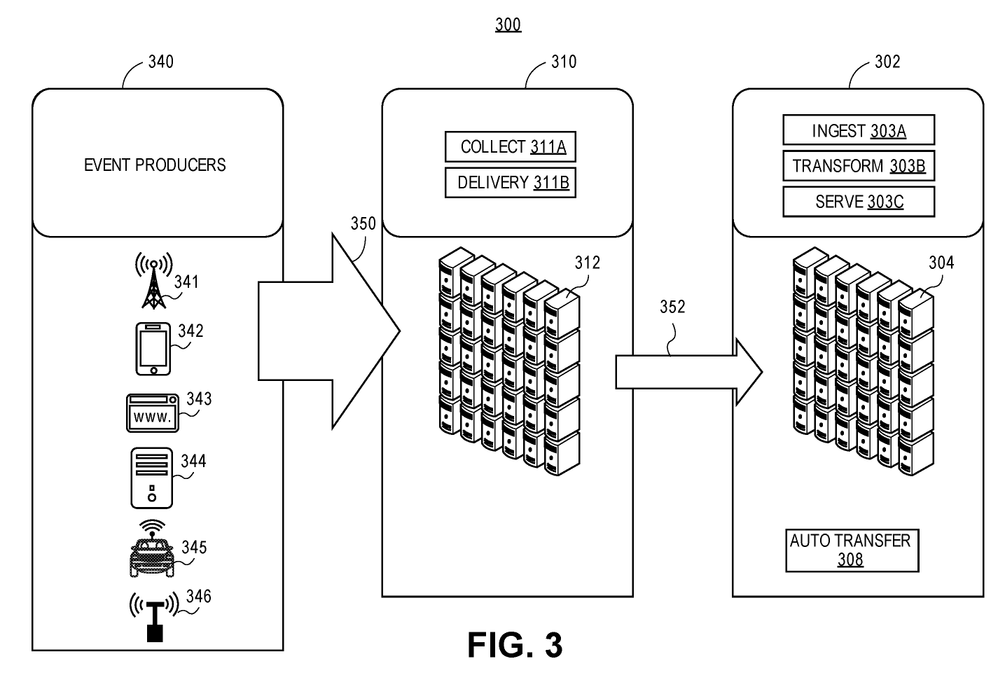

FIG. 3 shows an embodiment of a block diagram of a big data architecture 300 having automated controlled intelligence for transferring of big data computations from centralized systems to at least one of distributed nodes, event producers, and edge devices in accordance with one embodiment. A big data system 302 includes a plurality of servers 304, at least one of ingest 303a, transform 303b, and serve 303c layers or stages, and auto transfer feature 308 for automatically transferring of big data computations that typically occur in centralized systems (e.g., system 302) to at least one of distributed nodes 310 and event producers 340. The system 302 provides big data services by collecting data from event producers 340 (e.g., communication modules 341 (e.g., wireless networks), internet of things (IoT) device 345, mobile device 342, tablet device 344, computer 343, sensor device 346, etc.). A sensor device may include any type of sensor (e.g., environmental, temperature, humidity, automotive, electromagnetic, light, LIDAR, RADAR, etc.). Each event producer (e.g., edge device) may include a respective big data application (e.g., a data collecting software layer) for collecting any type of data that is associated with the event producer (e.g., user data, device type, network connection, display orientation, volume setting, language preference, location, web browsing data, transaction type, purchase data, etc.). Distributed nodes 310 include collect 311a and delivery 311b layers or stages (e.g., messaging systems) and resources 312 (e.g., web servers). Collected data 350 is transferred from the event producers to the distributed nodes 310 that transfer collected data 352 to the big data system 302 having at least one of ingest 303a, transform 303b, and serve 303c layers or stages. In this example, the auto transfer feature 308 causes computations that are normally performed with resources 304 of the system 302 to be transferred and performed with resources 312 of the distributed nodes 310 that filter the collected data 350 to generate a reduced set of data 352 as indicated by a reduced width of the arrow for data 352 in comparison to the width of the arrow for data 350. In one example, the filtering includes selecting a customer ID from a log in which customer country is US. The reduced set of data 352 is transferred to the system 302 for at least one of ingest 303a, transform 303b, and serve 303c layers or stages for further processing. The reduced set of data 352 reduces network congestion between the distributed nodes 310 and the system 302. The auto transfer feature 308 may also be located on the distributed nodes 310.

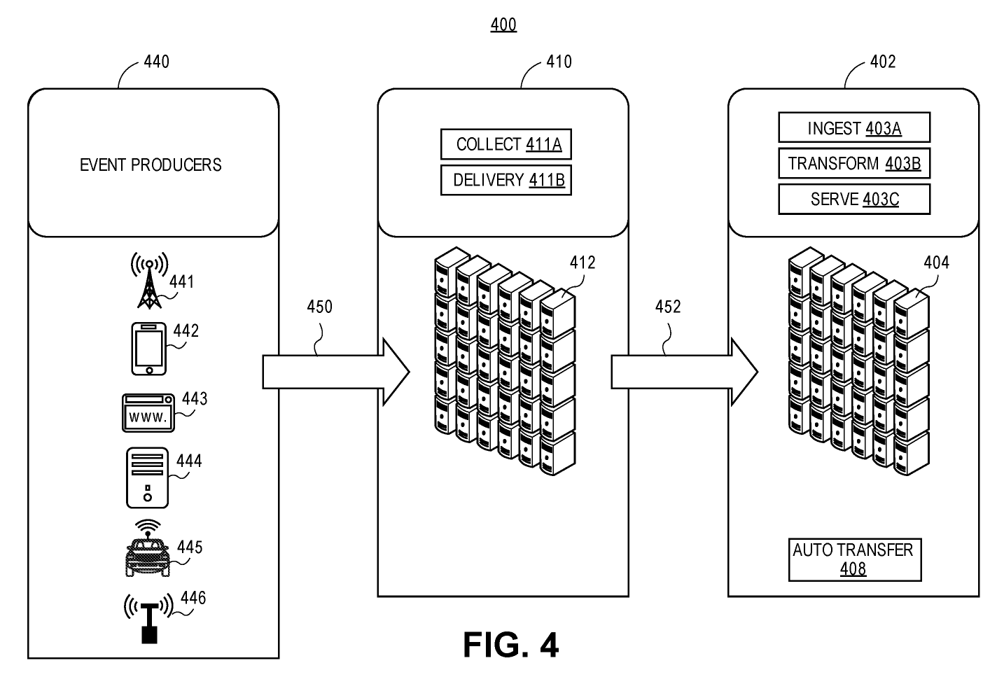

FIG. 4 shows an embodiment of a block diagram of a big data architecture 400 having automated controlled intelligence for transferring of big data computations from centralized systems to at least one of distributed nodes, event producers, and edge devices in accordance with one embodiment. A big data system 402 includes a plurality of servers 404, at least one of ingest 403a, transform 403b, and serve 403c layers or stages, and auto transfer feature 408 for automatically transferring of big data computations that typically occur in centralized systems (e.g., system 402) to at least one of distributed nodes, event producers, and edge devices. The system 402 provides big data services by collecting data from event producers 440 (e.g., communication modules 441 (e.g., wireless networks), internet of things (IoT) device 445, mobile device 442, tablet device 444, computer 443, sensor device 446, etc.). Each event producer (e.g., edge device) may include a respective big data application (e.g., a data collecting software layer) for collecting any type of data that is associated with the event producer (e.g., user data, device type, network connection, display orientation, volume setting, language preference, location, web browsing data, transaction type, purchase data, etc.). Distributed nodes 410 include collect 411a and delivery 411b layers or stages (e.g., messaging systems) and resources 412 (e.g., web servers). Collected data 450 is transferred from the event producers to the distributed nodes 410 that transfer collected data 452 to the big data system 402 having at least one of ingest, transform, and serve layers or stages. In this example, the auto transfer feature 408 causes computations that are normally performed with resources 404 of the system 402 to be transferred and performed with devices of the event producers 440 that filter the collected data to generate a reduced set of data 450 as indicated by a reduced width of the arrow for data 450 in comparison to the width of the arrow for data 250 and data 350. In one example, the filtering includes selecting a customer ID from a log in which customer country is US. The reduced set of data 452 is transferred to the system 402 for at least one of ingest 403a, transform 403b, and serve 403c layers or stages for further processing. The reduced set of data 452 reduces network congestion between the event producers and the distributed nodes 410 and also between the distributed nodes 410 and the system 402. The auto transfer feature 408 may also be located on the distributed nodes 410 and the event producers 440.

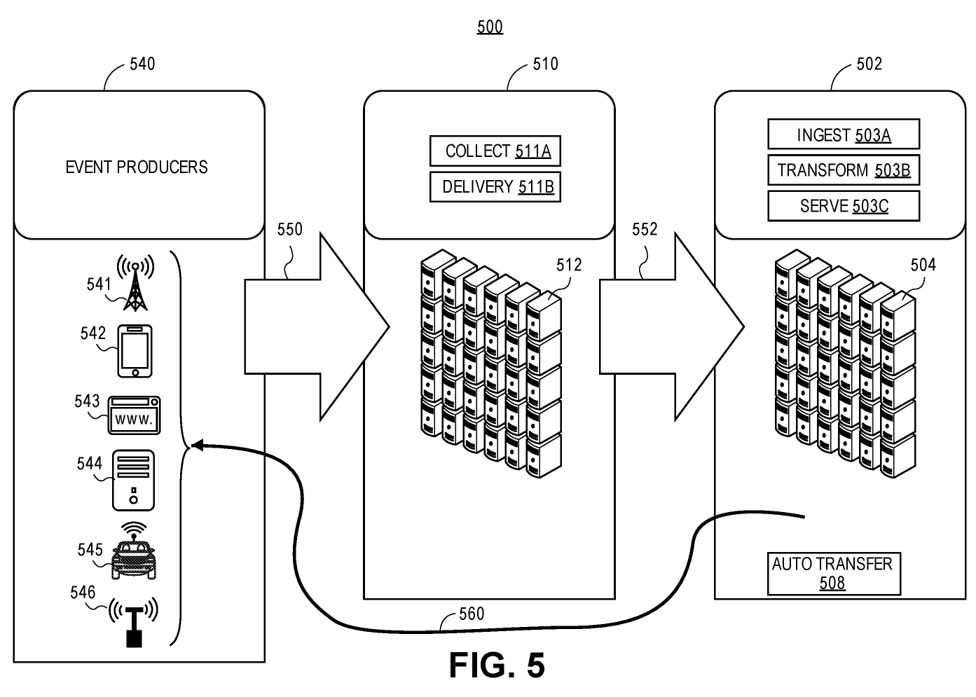

FIG. 5 shows an embodiment of a block diagram of a big data architecture 500 for providing big data applications for a plurality of devices in accordance with one embodiment. A big data system 502 includes a plurality of servers 504, at least one of ingest 503a, transform 503b, and serve 503c layers or stages, and an auto transfer feature 508 for automatically transferring of big data computations that typically occur in centralized systems (e.g., system 502) to at least one of distributed nodes, event producers, and edge devices. The system 502 provides big data services by collecting data from event producers 540 (e.g., communication modules 541, internet of things (IoT) device 545, mobile device 542, tablet device 544, computer 543, etc.). Each event producer may include a respective big data application (e.g., a data collecting software layer) for collecting any type of data that is associated with the event producer (e.g., user data, device type, network connection, display orientation, volume setting, language preference, location, web browsing data, transaction type, purchase data, etc.). Distributed nodes 510 include collect 511a and delivery 511b layers or stages (e.g., messaging systems) and resources 512 (e.g., web servers). Collected data 550 is transferred from the event producers to the distributed nodes 510 that transfer collected data 552 to the big data system 502 having at least one of ingest 503a, transform 503b, and serve 503c layers or stages that filter the collected and/or transformed data. In one example, the system 502 detects anomalous behavior from a user during the at least one of ingest 503a, transform 503b, and serve 503c layers or stages and bans the user from further access to a service and associated data being used by the user based on sending a communication 560 (e.g., command) to event producer(s) associated with the user that is to be banned.

In one example, the auto transfer feature 508 functions in a manner similar to the auto transfer features 308 and 408. The auto transfer feature 508 can cause computations that are normally performed with resources 504 of the system 502 to be transferred and performed with devices of the event producers 540 or resources 512 of the distributed nodes 510 that filter the collected data to generate a reduced set of data instead of data 550 and data 552. The auto transfer feature 508 may also be located on the distributed nodes 510 and the event producers 540.

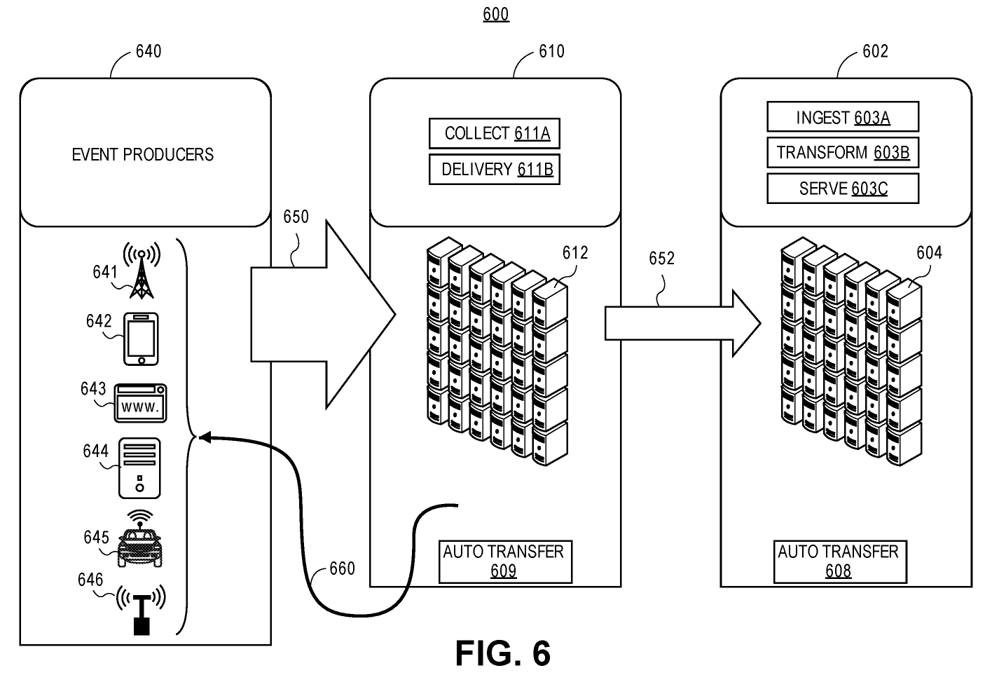

FIG. 6 shows an embodiment of a block diagram of a big data architecture 600 having automated controlled intelligence for transferring of big data computations from centralized systems to at least one of distributed nodes, event producers, and edge devices in accordance with one embodiment. A big data system 602 includes a plurality of servers 604, at least one of ingest 603a, transform 603b, and serve 603c layers or stages and auto transfer feature 608 for automatically transferring of big data computations that typically occur in centralized systems (e.g., system 602) to at least one of distributed nodes 610 and event producers 640. The system 602 provides big data services by collecting data from event producers 640 (e.g., communication modules 641, internet of things (IoT) device 645, mobile device 642, tablet device 644, computer 643, etc.). Each event producer may include a respective big data application (e.g., a data collecting software layer) for collecting any type of data that is associated with the event producer (e.g., user data, device type, network connection, display orientation, volume setting, language preference, location, web browsing data, transaction type, purchase data, etc.). Distributed nodes 610 include collect 611a and delivery 611b layers or stages (e.g., messaging systems) and resources 612 (e.g., web servers). Collected data 650 is transferred from the event producers to the distributed nodes 610 that transfer collected data 652 to the big data system 602 having at least one of ingest 603a, transform 603b, and serve 603c layers or stages. In this example, the auto transfer feature 608 causes computations that are normally performed with resources 604 of the system 602 to be transferred and performed with resources 612 of the distributed nodes 610 that filter the collected data 650 to generate a reduced set of data 652 as indicated by a reduced width of the arrow for data 652 in comparison to the width of the arrow for data 650. In one example, the system 602 detects anomalous behavior from a user during the collect 611a and delivery 611b stage and bans the user from further access to a service and associated data being used by the user based on sending a communication 660 (e.g., command) to event producer(s) associated with the user that is to be banned. The communication 660 travels a shorter distance in comparison to the communication 560 and thus has a reduced response time and lower latency compared to the communication 560 in FIG. 5. The reduced set of data 652 is transferred to the system 602 for at least one of ingest 603a, transform 603b, and serve 603c stages for further processing. The reduced set of data 652 reduces network congestion between the distributed nodes 610 and the system 602. The auto transfer feature 608 may also be located on the distributed nodes 610 in another embodiment as illustrated with auto transfer feature 609.

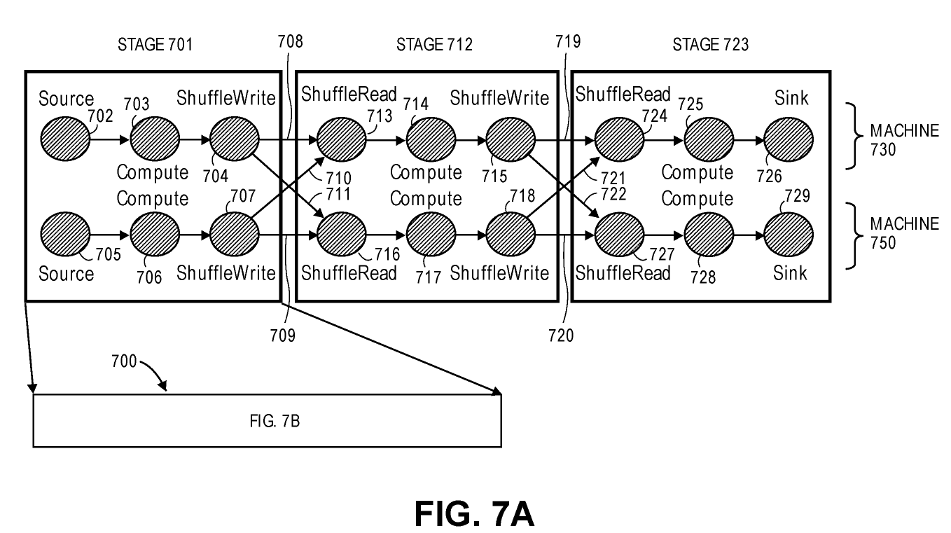

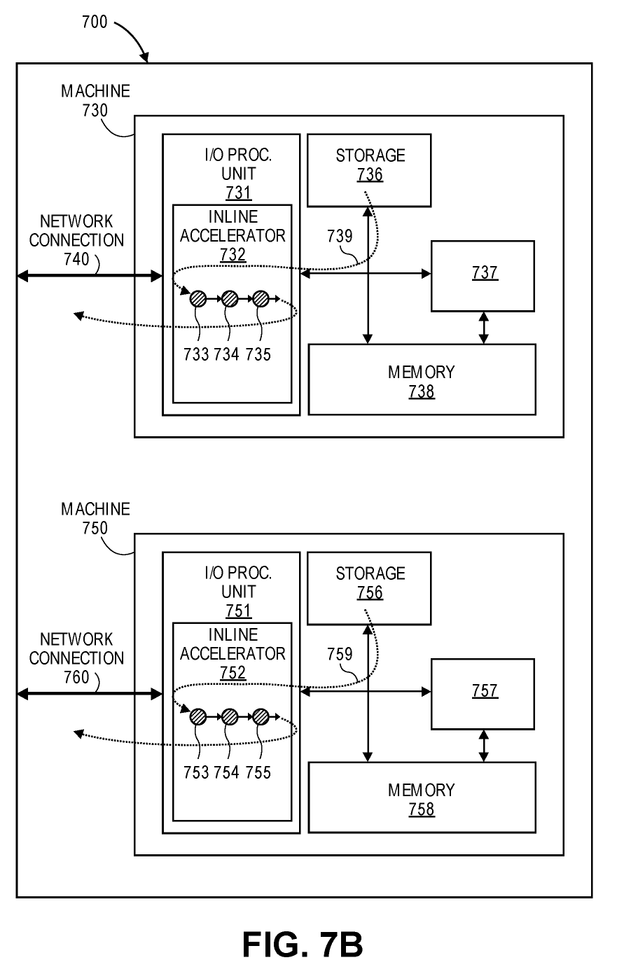

FIGS. 7A and 7B show an example of big data computation that includes three stages running on multiple machines in accordance with one embodiment. In a first stage 701 of a data processing system 700 as illustrated in FIGS. 7A and 7B, the present design reads data from a source storage 702 and 705, performs computations 703 and 706 on data, and shuffles (e.g., reorganization, aggregation) the data between the computation nodes at shuffle write operations 704 and 707 that output 708-711 this data to a shuffle read operations 713 and 716 of the second stage 712. The second stage also includes computations 714 and 717, shuffle write operations 715 and 718, and outputs 719-722. Shuffle read operations 724 and 727 of the third stage 723 (e.g., ingest and transform stage) receive the outputs, computations 725 and 728 are performed, and results are written into sink storage 726 and 729. A machine 730 (e.g., server, distributed node, edge device) performs the operations 702-704, 713-715, and 724-726. The machine 730 includes an I/O processing unit 731 (e.g., network interface card 731) having an in-line accelerator 732. The machine 730 also includes storage 736, general purpose instruction-based processor 737, and memory 738. A data path 739 illustrates the data flow for machine 730 for stage 701. For example, data is read from a source storage 702 of storage 736 (e.g., operation 733) and computations 703 (e.g., operation 734) and shuffle write operations 704 (e.g., operation 735) are performed by the in-line accelerator 732. The outputs 708 and 711 are sent to a second stage 712 via a network connection 740.

A machine 750 (e.g., server, distributed node, edge device) performs the operations 705-707, 716-718, and 727-729. The machine 750 includes an I/O processing unit 751 (e.g., network interface card 751) having an in-line accelerator 752. The machine 750 also includes storage 756, general purpose instruction-based processor 757, and memory 758. The machine 750 also includes storage 756, general purpose instruction-based processor 757, and memory 758. A data path 759 illustrates the data flow for machine 750 for stage 701. For example, data is read from a source storage 705 of storage 756 (e.g., operation 753), computations 706 (e.g., operation 754) and shuffle write operations 707 (e.g., operation 755) are performed by the in-line accelerator 752. The outputs 709-710 are sent to a second stage 712 via a network connection 760. The machines 730 and 750 can be a distributed resource (e.g., a messaging system, a data collection system, a collect and delivery stage), an event producers stage, or an edge device for performing computations that are typically performed with a centralized resource.

In one embodiment, since shuffle does not occur in the stage 701, the present design can automatically move computation to a distributed resource (e.g., a messaging system, a data collection system, a collect and delivery stage) or an event producers stage as there is no need for communication between different locations of the data.

In one example, two sources 702 and 705 have different locations. The data from source 702 is joined (e.g., SQL join) to the data from the source 705. These operations require a shuffle, which is why a scheduler (e.g., compiler, auto transfer function) creates separate stages. In this example, the data obtained from source 702 changes frequently over time while data obtained from source 705 almost never changes.

In these cases, the centralized system can act intelligently and push the data associated with the source 705 closer to an edge of a network or near a device location that is associated with source 702, and then perform the join in these edge or device locations (instead of doing the join at the centralized system). As the data from source 705 changes infrequently, the data transfer cost is low. Pushing the data from source 705 closer to source 702, the present design allows more computing on the edge or near the device location that is associated with source 702, even without sending the data to a data center of the centralized system.

In another example, two sources 702 and 705 have different locations. In this case, source 702 and source 705 are close to each other (e.g., connected in the same edge device or near the same edge device). The shuffle operation (e.g., 704, 707, 713, 716, 715, 718) can happen on the edge device because the data for both of these sources passes by the particular edge device. In both cases, the system can act intelligently and push multiple stages (e.g., 712, 701) to the edge device.

The system can utilize a cost function to intelligently analyze these tradeoffs by factoring in how much network bandwidth can be saved. This cost function can also factor in the latency reduction associated with pushing data to the edge, and adjust how to weigh latency based on a level of latency-sensitivity for a particular application. Pushing computation to the edge in this manner allows for the latency of mission critical applications to be reduced.

In fact, if these data sources are sensor devices, by writing the dataflow computation (e.g. SQL query) that performs join between these two sources of data, the present design pushes this join closer to the sensors and applications. Applications such as sensor fusion, can be written using a declarative language like SQL, and can be distributed and optimized in terms of bandwidth and latency.

There are many ways to implement this idea of automatic extraction of the computation that can be moved from a centralized system to distributed nodes (e.g., messaging/logging layer, data collection layer), event producers, sensors, or edge devices. One simple way for cases having ingestion/enrichment is done using a framework (e.g., Spark). Since computation is split between the stages, shuffling between different partitions of the data is done only between stages. If the source of the first stage is from an external stream of data from a messaging system, the computations in the first stage can be done independently without requiring any shuffle (if there is any computation at all). Therefore, the present design automatically moves that computation to a messaging system (e.g., Kafka) or even a logging/data collection system (e.g., web servers, sensors).

For example, when a data ingestion engine runs an ETL on the incoming data and for a line like this,

JOE Mar. 12, 2013 HTTP://domain_name.com

Create a corresponding JSON (JavaScript Object Notation) entry

In one example of an implementation in Spark:

```
      (0) to (3) where it leads to shuffle can be detected and offloaded
to the messaging system (e.g., Kafka).
    val logs = createDirect messaging system Connection(messaging
    system_broker, topic)
    For each (log in logs) {
    val jsonRDD = log.map(log2json) // (0) convert to json
      val logsDF = sqlContext.read(schema).json(jsonRDD)
      logsDF.filter(“page is not null and user is not null”) // (1) Cleaning
        .join(“user”, user_id_table) // (2) Adding user ids
          .groupBy(“user_id”).agg(count(“user”)) // (3) Aggregating
    }
```

Thus, a compiler can get this computation and push it to the servers of the messaging system or even to web servers.

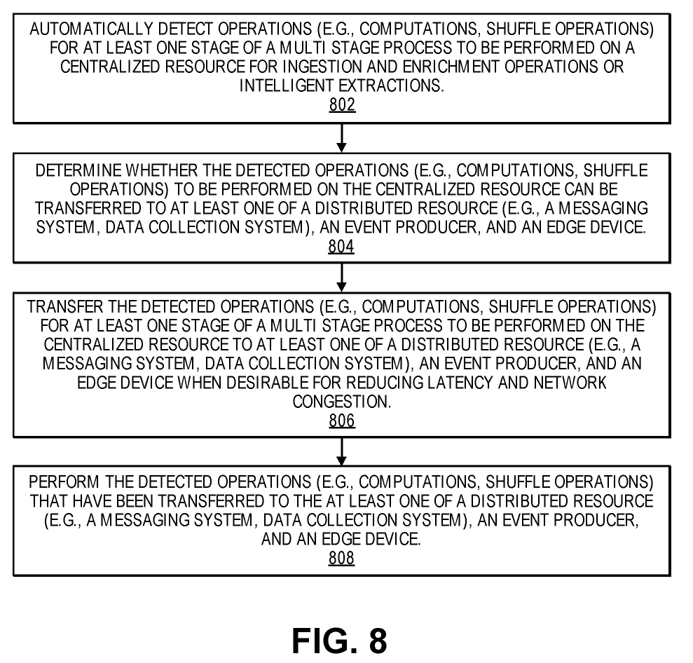

FIG. 8 is a flow diagram illustrating a method 800 for automatically moving operations (e.g., computations, shuffle operations) from a centralized resource to at least one of a distributed resource (e.g., a messaging system, data collection system), an event producer, and an edge device for distributed multi stage dataflow according to an embodiment of the disclosure. Although the operations in the method 800 are shown in a particular order, the order of the actions can be modified. Thus, the illustrated embodiments can be performed in a different order, and some operations may be performed in parallel. Some of the operations listed in FIG. 8 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 800 may be executed by a compiler component, a data processing system, a machine, a server, a web appliance, a centralized system, a distributed node, or any system, which includes an in-line accelerator. The in-line accelerator may include hardware (circuitry, dedicated logic, etc.), software (such as is run on a general purpose computer system or a dedicated machine or a device), or a combination of both. In one embodiment, a compiler component performs the operations of method 800.

At operation 802, the method includes automatically detecting operations (e.g., computations, shuffle operations) for at least one stage of a multi stage process to be performed on a centralized resource for ingestion and enrichment operations or intelligent extractions. At operation 804, the method determines whether the detected operations to be performed on the centralized resource can be transferred to at least one of a distributed resource (e.g., a messaging system, data collection system), an event producer, and an edge device. At operation 806, the method transfers the detected operations for at least one stage of a multi stage process to be performed on the centralized resource to at least one of a distributed resource (e.g., a messaging system, data collection system), an event producer, and an edge device when desirable for reducing latency and network congestion. At operation 808, the method performs the detected operations that have been transferred to the at least one of a distributed resource (e.g., a messaging system, data collection system), an event producer, and an edge device. In one example, at least one of a distributed resource (e.g., a messaging system, data collection system), an event producer, and an edge device having an I/O processing unit of a machine (e.g., server, distributed node, edge device) and an in-line accelerator is configured for at least one stage of a multi stage process to read the transferred data from the storage, to perform computations on the data, and to shuffle a result of the computations to generate a set of shuffled data to be transferred to a subsequent stage of operations.

In another embodiment, the computations to be transferred can be transferred to a messaging system having in-line hardware for significantly higher performance without impacting any other resources in a system.

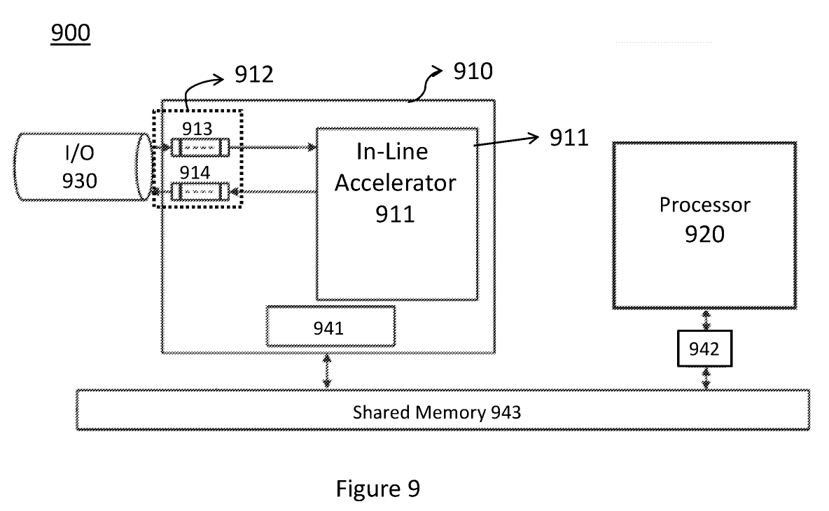

FIG. 9 illustrates the schematic diagram of data processing system 900 according to an embodiment of the present invention. Data processing system 900 includes I/O processing unit 910 and general purpose instruction-based processor 920. In an embodiment, general purpose instruction-based processor 120 may include a general purpose core or multiple general purpose cores. A general purpose core is not tied to or integrated with any particular algorithm. In an alternative embodiment, general purpose instruction-based processor 920 may be a specialized core. I/O processing unit 910 may include in-line accelerator 911. In-line accelerators are a special class of accelerators that may be used for I/O intensive applications. In-line accelerator 911 and general purpose instruction-based processor may or may not be on a same chip. In-line accelerator 911 is coupled to I/O interface 912. Considering the type of input interface or input data, in one embodiment, the in-line accelerator 911 may receive any type of network packets from a network 930 and an input network interface card (NIC). In another embodiment, the accelerator maybe receiving raw images or videos from the input cameras. In an embodiment, in-line accelerator 911 may also receive voice data from an input voice sensor device.

In an embodiment, in-line accelerator 911 is coupled to multiple I/O interfaces (not shown in the figure). In an embodiment, input data elements are received by I/O interface 912 and the corresponding output data elements generated as the result of the system computation are sent out by I/O interface 912. In an embodiment, I/O data elements are directly passed to/from in-line accelerator 911. In processing the input data elements, in an embodiment, in-line accelerator 911 may be required to transfer the control to general purpose instruction-based processor 920. In an alternative embodiment, in-line accelerator 911 completes execution without transferring the control to general purpose instruction-based processor 920. In an embodiment, in-line accelerator 911 has a master role and general purpose instruction-based processor 920 has a slave role.

In an embodiment, in-line accelerator 911 partially performs the computation associated with the input data elements and transfers the control to other accelerators or the main general purpose instruction-based processor in the system to complete the processing. The term “computation” as used herein may refer to any computer task processing including, but not limited to, any of arithmetic/logic operations, memory operations, I/O operations, and offloading part of the computation to other elements of the system such as general purpose instruction-based processors and accelerators. In-line accelerator 911 may transfer the control to general purpose instruction-based processor 920 to complete the computation. In an alternative embodiment, in-line accelerator 911 performs the computation completely and passes the output data elements to I/O interface 912. In another embodiment, in-line accelerator 911 does not perform any computation on the input data elements and only passes the data to general purpose instruction-based processor 920 for computation. In another embodiment, general purpose instruction-based processor 920 may have in-line accelerator 911 to take control and completes the computation before sending the output data elements to the I/O interface 912.

In an embodiment, in-line accelerator 911 may be implemented using any device known to be used as accelerator, including but not limited to field-programmable gate array (FPGA), Coarse-Grained Reconfigurable Architecture (CGRA), general-purpose computing on graphics processing unit (GPGPU), many light-weight cores (MLWC), network general purpose instruction-based processor, I/O general purpose instruction-based processor, and application-specific integrated circuit (ASIC). In an embodiment, I/O interface 912 may provide connectivity to other interfaces that may be used in networks, storages, cameras, or other user interface devices. I/O interface 912 may include receive first in first out (FIFO) storage 913 and transmit FIFO storage 914. FIFO storages 913 and 914 may be implemented using SRAM, flip-flops, latches or any other suitable form of storage. The input packets are fed to the in-line accelerator through receive FIFO storage 913 and the generated packets are sent over the network by the in-line accelerator and/or general purpose instruction-based processor through transmit FIFO storage 914.

In an embodiment, I/O processing unit 910 may be Network Interface Card (NIC). In an embodiment of the invention, in-line accelerator 911 is part of the NIC. In an embodiment, the NIC is on the same chip as general purpose instruction-based processor 920. In an alternative embodiment, the NIC 910 is on a separate chip coupled to general purpose instruction-based processor 920. In an embodiment, the NIC-based in-line accelerator receives an incoming packet, as input data elements through I/O interface 912, processes the packet and generates the response packet(s) without involving general purpose instruction-based processor 920. Only when in-line accelerator 912 cannot handle the input packet by itself, the packet is transferred to general purpose instruction-based processor 920. In an embodiment, in-line accelerator 912 communicates with other I/O interfaces, for example, storage elements through direct memory access (DMA) to retrieve data without involving general purpose instruction-based processor 920.

In-line accelerator 911 and the general purpose instruction-based processor 920 are coupled to shared memory 943 through private cache memories 941 and 942 respectively. In an embodiment, shared memory 943 is a coherent memory system. The coherent memory system may be implemented as shared cache. In an embodiment, the coherent memory system is implemented using multiples caches with coherency protocol in front of a higher capacity memory such as a DRAM.

Processing data by forming two paths of computations on in-line accelerators and general purpose instruction-based processors (or multiple paths of computation when there are multiple acceleration layers) have many other applications apart from low-level network applications. For example, most emerging big-data applications in data centers have been moving toward scale-out architectures, a technology for scaling the processing power, memory capacity and bandwidth, as well as persistent storage capacity and bandwidth. These scale-out architectures are highly network-intensive. Therefore, they can benefit from in-line acceleration. These applications, however, have a dynamic nature requiring frequent changes and modifications. Therefore, it is highly beneficial to automate the process of splitting an application into a fast-path that can be executed by an in-line accelerator and a slow-path that can be executed by a general purpose instruction-based processor as disclosed herein.

While embodiments of the invention are shown as two accelerated and general-purpose layers throughout this document, it is appreciated by one skilled in the art that the invention can be implemented to include multiple layers of in-line computation with different levels of acceleration and generality. For example, an in-line FPGA accelerator can backed by an in-line many-core hardware. In an embodiment, the in-line many-core hardware can be backed by a general purpose instruction-based processor.

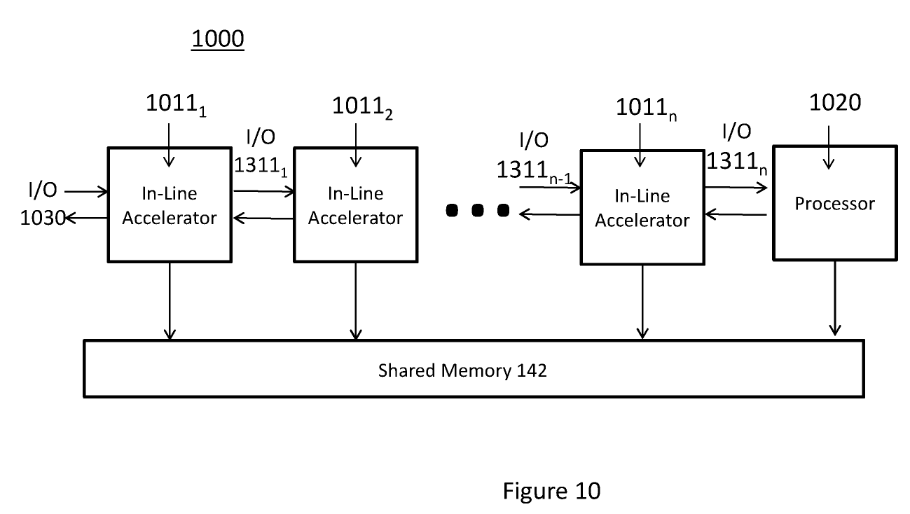

Referring to FIG. 10, in an embodiment of invention, a multi-layer system 1000 is formed by a first in-line accelerator 1011₁ and several other in-line accelerators 1011ₙ. The multi-layer system 1000 includes several accelerators, each performing a particular level of acceleration. In such a system, execution may begin at a first layer by the first in-line accelerator 1011₁. Then, each subsequent layer of acceleration is invoked when the execution exits the layer before it. For example, if the in-line accelerator 1011₁ cannot finish the processing of the input data, the input data and the execution will be transferred to the next acceleration layer, in-line accelerator 1011₂. In an embodiment, the transfer of data between different layers of accelerations may be done through dedicated channels between layers (1311₁ to 1311ₙ). In an embodiment, when the execution exits the last acceleration layer by in-line accelerator 1011ₙ, the control will be transferred to the general-purpose core 1020.

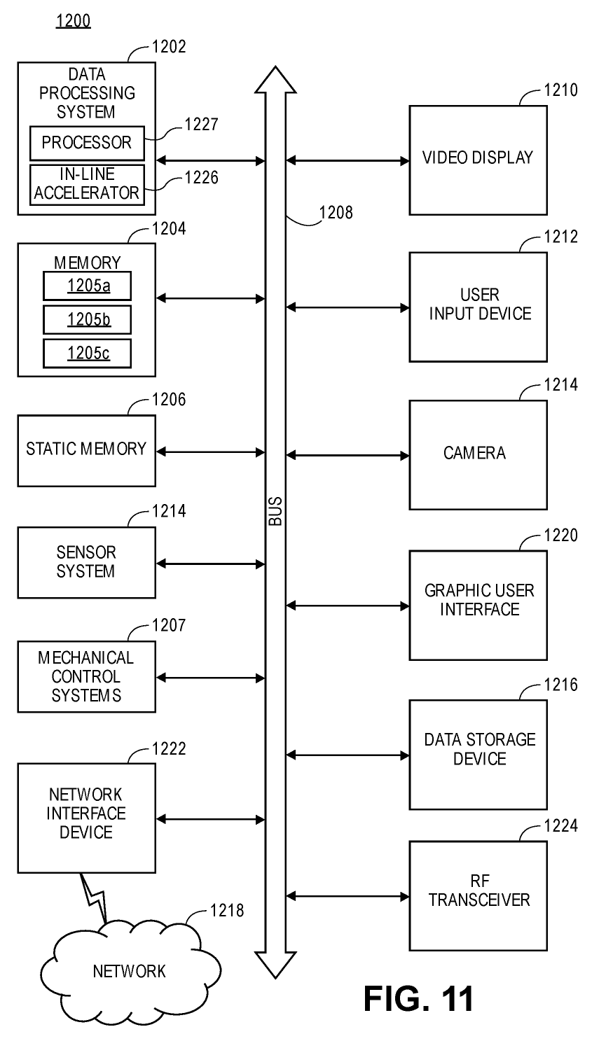

FIG. 11 is a diagram of a computer system including a data processing system according to an embodiment of the invention. Within the computer system 1200 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general purpose instruction-based processor 1227 and an in-line accelerator 1226. The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The in-line accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227 or in-line accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and in-line accelerator 1226 execute various software components stored in memory 1204 to perform various functions for system 1200. In one embodiment, the software components include operating system 1205a, compiler component 1205b having an auto transfer feature (e.g., 308, 408, 508, 608), and communication module (or set of instructions) 1205c. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code). A communication module 1205c provides communication with other devices utilizing the network interface device 1222 or RF transceiver 1224.

The computer system 1200 may further include a network interface device 1222. In an alternative embodiment, the data processing system disclose is integrated into the network interface device 1222 as disclosed herein. The computer system 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphic User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable storage medium (or more specifically a computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

In one example, the computer system 1200 is an autonomous vehicle that may be connected (e.g., networked) to other machines or other autonomous vehicles in a LAN, WAN, or any network. The autonomous vehicle can be a distributed system that includes many computers networked within the vehicle. The autonomous vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The autonomous vehicle can operate in the capacity of a server or a client in a client-server network environment, or as a peer machine in a peer-to-peer (or distributed) network environment. The storage units disclosed in computer system 1200 may be configured to implement data storing mechanisms for performing the operations of autonomous vehicles.

The computer system 1200 also includes sensor system 1214 and mechanical control systems 1207 (e.g., motors, driving wheel control, brake control, throttle control, etc.). The processing system 1202 executes software instructions to perform different features and functionality (e.g., driving decisions) and provide a graphical user interface 1220 for an occupant of the vehicle. The processing system 1202 performs the different features and functionality for autonomous operation of the vehicle based at least partially on receiving input from the sensor system 1214 that includes laser sensors, cameras, radar, GPS, and additional sensors. The processing system 1202 may be an electronic control unit for the vehicle.

The present design transfers computations towards different types of devices, such as mobile devices, browsers, or vehicles. Edge devices can act as telecommunication-based stations, network point-of-presence, so on so forth, and data centers are located with a centralized system. However, pushing the computation automatically is not limited to these architectures. For example, the present design may include three layers inside a vehicle, such that, end devices are sensors (e.g., sensor system 1214) and edge devices might be some communication hubs (e.g., network interface device 1222) and the centralized system is an ECU 1202 in a vehicle 1200. Even in this case, the present design may be optimized by pushing computations from the ECU to communication hubs to improve throughput and reduce latency.

In one example, a big data computation may receive first source data from a first autonomous vehicle and simultaneously receive second source data from a second autonomous vehicle that has a close proximity to the first autonomous vehicle. The first and second source data may include dynamic real-time data including location, vehicle identifiers, sensor data (e.g., LiDAR, RADAR, tire pressure, etc.), and video streams. A join operation can join different parameters from these data sources including in one example location fields to determine if the vehicles may be in close proximity to each other. The location fields and potential other fields (e.g., sensor data) can be analyzed to determine if an alarm collision condition occurs. If so, the vehicles can be notified immediately to prevent a collision between the vehicles.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A centralized system for big data services comprising:
storage to store data for big data services;
a plurality of servers coupled to the storage, the plurality of servers to perform at least one of ingest, transform, and serve stages of data; and
a sub-system having an auto transfer feature to perform program analysis on computations of the data and to automatically detect computations to be transferred from within the centralized system to at least one of an event producer and an edge device.

2. The centralized system of claim 1, wherein the auto transfer feature causes computations of data that are normally performed with the centralized system to be transferred and performed with resources of the at least one of an event producer and an edge device.

3. The centralized system of claim 2, wherein the at least one of an event producer and an edge device receives data and filters the collected data to generate a reduced set of data.

4. The centralized system of claim 3, wherein the plurality of servers to perform at least one of ingest, transform, and serve stages for the reduced set of data instead of the collected data received by the at least one of an event producer and an edge device to reduce networking congestion for data transferred between the at least one of an event producer and an edge device and the centralized system.

5. The centralized system of claim 1, wherein the auto transfer feature causes computations of data that are normally performed with the centralized system to be performed with devices of the event producers.

6. The centralized system of claim 5, wherein the devices of the event producers filter the data to produce a reduced set of data that is received by at least one distributed node.

7. The centralized system of claim 6, wherein the plurality of servers to perform at least one of ingest, transform, and serve stages for the reduced set of data that is filtered by the devices of the event producers to reduce network congestion for data transferred between the event producers, the at least one distributed node, and the centralized system.

8. A machine comprising:
storage to store data; and
an Input/output (I/O) processing unit coupled to the storage, the I/O processing unit having an in-line accelerator that is configured for in-line stream processing of distributed multi stage dataflow based computations including automated controlled intelligence for transferring of data computations and at least one shuffle operation from the machine to at least one of an event producer and an edge device.

9. The machine of claim 8, wherein the in-line accelerator is further configured to perform at least one of ingest, transform, and serve operations.

10. The machine of claim 8, wherein the in-line accelerator is further configured to receive a reduced set of data from the at least one of an event producer and an edge device that performs the transferred data computations and the at least one shuffle operation instead of collected data received by the at least one of an event producer and an edge device.

11. The machine of claim 8, further comprising:
a general purpose instruction-based processor coupled to the I/O processing unit, wherein the in-line accelerator is configured to perform operations of multiple stages without utilizing the general purpose instruction-based processor.

12. The machine of claim 8, wherein the at least one of an event producer and an edge device receives a first set of data from a first data source and a second set of data from a second data source to perform the data computations and the at least one shuffle operation.

13. The machine of claim 12, wherein the first data source has a different location than the second data source.

14. The machine of claim 13, wherein at least one of the first data source and the second data source have a different location than the at least one of an event producer and an edge device.

15. The machine of claim 8, wherein the automated controlled intelligence utilizes a cost function that is based on reducing network congestion and latency reduction to intelligently determine when to transfer data computations and at least one shuffle operation from the machine to the at least one of an event producer and an edge device.

16. A computer-implemented method comprising:
automatically detecting operations for at least one stage of a multi stage process to be performed on a centralized resource for ingestion and enrichment operations or intelligent extractions;
determining whether the detected operations to be performed on the centralized resource can be transferred to at least one of a distributed resource, an event producer, and an edge device; and
transferring the detected operations for at least one stage of a multi stage process to be performed on the centralized resource to at least one of a distributed resource, an event producer, and an edge device when desirable for reducing latency and network congestion between the centralized resource and the at least one of a distributed resource, an event producer, and an edge device.

17. The computer-implemented method of claim 16, further comprising:
performing the detected operations that have been transferred to the at least one of a distributed node, an event producer, and an edge device to generate a reduced set of data.

18. The computer-implemented method of claim 17, further comprising:
receiving with the centralized resource the reduced set of data from the at least one of a distributed node, an event producer, and an edge device; and
performing at least one of ingest, transform, and serve stages for the reduced set of data to reduce networking congestion for data transferred between the centralized resource and the at least one of a distributed node, an event producer, and an edge device.

19. An edge device comprising:
storage to store data; and
a processing unit coupled to the storage, the processing unit is configured for processing of distributed multi stage dataflow based operations including data computations and at least one shuffle operation for a first set of data from a first data source and a second set of data from a second data source.

20. The edge device of claim 19, wherein automated controlled intelligence of a centralized resource causes the data computations and the at least one shuffle operation that are normally performed with the centralized resource to be transferred and performed with the processing unit of the edge device.

21. The edge device of claim 20, wherein automated controlled intelligence of the edge device causes the data computations and the at least one shuffle operation that are normally performed with a centralized resource to be transferred and performed with the processing unit of the edge device.

22. The edge device of claim 20, wherein the edge device to transfer a reduced set of data to the centralized resource for additional processing with the reduced set of data reducing networking congestion for data transferred between the centralized resource and the edge device.

23. A computer-readable storage medium comprising executable instructions to cause a processing system of a vehicle to perform operations of distributed multi stage dataflow, the instructions comprising:
automatically detecting operations for at least one stage of a multi stage dataflow to be performed on the processing system of the vehicle for ingestion and enrichment operations or intelligent extractions;
determining whether the detected operations to be performed on the processing system can be transferred to at least one of a communication hub of the vehicle and a sensor system of the vehicle; and
transferring the detected operations for at least one stage of a multi stage dataflow to be performed on the processing system to at least one of the communication hub and the sensor system when desirable for reducing latency and network congestion between at least one of the communication hub and the sensor system of the vehicle and the processing system.

24. The computer-readable storage medium of claim 23, further comprising:
performing the detected operations that have been transferred to at least one of the communication hub and the sensor system to generate a reduced set of data.

25. The computer-readable storage medium of claim 23, wherein the at least one of the communication hub and the sensor system receives a first set of data from a first data source and a second set of data from a second data source having a different location than the first data source.
